(19) United States
(12) Patent Application Publication
(10) Pub. No.: US 2023/0038815 A1
(43) Pub. Date: Feb. 9, 2023

(54) VEHICLE CONTROL DEVICE

(71) Applicant: DENSO CORPORATION, Kariya-city (JP)

(72) Inventor: Masaki KOUNO, Kariya-city (JP)

(73) Assignee: DENSO CORPORATION, Kariya-city (JP)

(21) Appl. No.: 17/970,773

(22) Filed: Oct. 21, 2022

Related U.S. Application Data
(63) Continuation of application No. PCT/JP2021/014339, filed on Apr. 2, 2021.

(30) Foreign Application Priority Data
Apr. 24, 2020 (JP) 2020-077286

(51) Int. Cl. B60W 30/045; B60W 10/08; B60W 40/114

(52) U.S. Cl. CPC B60W 30/045; B60W 10/08; B60W 40/114; B60W 2710/083; B60W 2540/18

(57) ABSTRACT

A vehicle control device includes a motor control unit, a turning control unit, and a turning information detection unit. The motor control unit controls electric motor. The turning control unit controls a turning device. The vehicle control device, by the motor control unit controlling the electric motor and the turning control unit controlling the turning device when the turning information detection unit detects information related to turning of the wheels, controls a turning force as a force to be applied to the tire of the wheel in order to turn the vehicle.

### CROSS-REFERENCE TO RELATED APPLICATION

The present application is a continuation application of International Application No. PCT/JP2021/014339, filed on Apr. 2, 2021, which claims priority to Japanese Patent Application No. 2020-077286, filed on Apr. 24, 2020. The contents of these applications are incorporated herein by reference in their entirety.

### BACKGROUND

### Technical Field

The present disclosure relates to a vehicle control device.

### Background Art

Conventionally, there are vehicle control devices described below. The vehicle control device includes a target turning amount calculation unit, a tire force calculation unit, a limit tire force estimation unit, a steering force control unit, a braking/driving force control unit, and a control sharing ratio setting unit. The target turning amount calculation unit calculates a target turning amount of an own vehicle based on an environment in front of the own vehicle. The tire force calculation unit calculates a tire force generated by steered wheel tires. The limit tire force estimation unit estimates a limit tire force of the steered wheel tires. The steering force control unit controls a steering force applied to a steering mechanism. The braking/driving force control unit controls a braking/driving force difference between left and right wheels. The control sharing ratio setting unit sets a target steering force of the steering force control unit and the target braking/driving force difference of the braking/driving force control unit by allocating the target turning amount at a predetermined control sharing ratio, and increases the control sharing ratio of the braking/driving force control unit for the steering force control unit as the tire force approaches the limit tire force. As a result, turning of the vehicle can be performed mainly by steering force control in a state in which there is a sufficient allowance in the tire force, and it is possible to prevent the driver from feeling discomfort due to acceleration or deceleration caused by intervention of the braking/driving force. In addition, in a case where there is little allowance in the tire force, turning of the vehicle can be reliably performed by increasing the control sharing ratio of the braking/driving force control.

### SUMMARY

In the present disclosure, provided is a vehicle control device as the following.

The vehicle control device includes a motor control unit, a turning control unit, and a turning information detection unit. The motor control unit controls electric motor. The turning control unit controls a turning device. The vehicle control device, by the motor control unit controlling the electric motor and the turning control unit controlling the turning device when the turning information detection unit detects information related to turning of the wheels, controls a turning force as a force to be applied to the tire of the wheel in order to turn the vehicle.

### BRIEF DESCRIPTION OF THE DRAWINGS

FIG. 1 is a block diagram illustrating a schematic configuration of a vehicle according to an embodiment.

FIG. 2 is a block diagram illustrating an electrical configuration of a vehicle according to an embodiment.

FIG. 3 is a diagram schematically illustrating force applied to tires when a vehicle of a comparative example turns.

FIG. 4 is a diagram schematically illustrating force applied to tires when a vehicle according to an embodiment turns.

FIG. 5 is a flowchart illustrating a procedure of processing executed by an ECU according to an embodiment.

FIG. 6 is a block diagram illustrating a configuration of an ECU according to an embodiment.

FIG. 7 is a block diagram illustrating a procedure of processing executed by a target value calculation unit according to an embodiment.

FIG. 8 is a map illustrating a relationship between a steering angle θs and a vehicle turning force T used by a target value calculation unit according to an embodiment.

FIG. 9 is a block diagram illustrating a schematic configuration of a vehicle according to another embodiment.

### DETAILED DESCRIPTION OF THE PREFERRED EMBODIMENTS

[PTL 1] JP 2010-69984 A

In a control device for performing turning of a vehicle using a steering force and a braking/driving force difference as described in Patent Document 1, the steering angle and the braking/driving force are often controlled according to the situation of the vehicle each time. When the turning angle and braking/driving force can be controlled so that the force applied to the tires when the vehicle is turning can be efficiently used, turning performance of the vehicle can be improved, and thus effects such as further improving the drivability of the vehicle can be expected.

An object of the present disclosure is to provide a vehicle control device capable of improving turning performance of a vehicle.

The vehicle control device according to one aspect of the present disclosure is a control device configured to control a traveling vehicle by transmitting torque from an electric motor to a wheel. The control device includes a motor control unit, a turning control unit, and a turning information detection unit. The motor control unit is configured to control the electric motor. The turning control unit is configured to control a turning device that causes turning of the wheel. The turning information detection unit is configured to detect information related to turning of the wheel. The vehicle control device is configured to, by the motor control unit controlling the electric motor and the turning control unit controlling the turning device when the turning information detection unit detects information related to turning of the wheels, control a turning force serving as a force to be applied to tire of the wheel in order to turn the vehicle.

When the turning force to be applied to the tires of the wheels is calculated and then an optimum turning angle command value and torque command values are set based on this turning vector as in this configuration, it is possible to apply a turning force capable of efficiently utilizing a tire lateral force to the tires. Therefore it is possible to improve the turning performance of the vehicle.

An embodiment of a vehicle control device will be described below with reference to the drawings. In order to facilitate understanding of the description, the same components are denoted by the same reference numerals as much as possible in each drawing, and redundant descriptions are omitted.

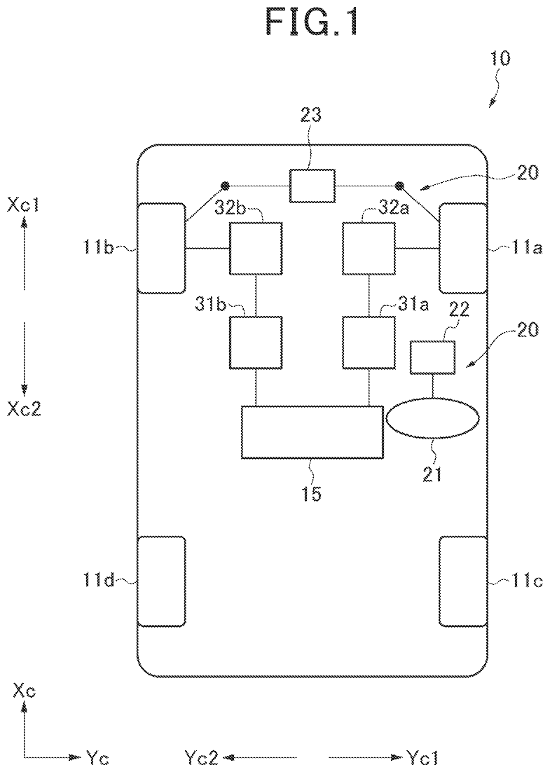

First, referring to FIG. 1, a schematic configuration of a vehicle 10 according to the present embodiment will be described. As illustrated in FIG. 1, the vehicle 10 includes a steering device 20, inverter devices 31a and 31b, and motor generators 32a and 32b.

The steering device 20 is a so-called steer-by-wire type steering device in which a steering wheel 21 operated by a driver and wheels 11a and 11b are not mechanically connected. The steering device 20 has a steering angle sensor 22 and a turning device 23. The steering angle sensor 22 detects a steering angle θs, which is a rotation angle of the steering wheel 21, and outputs a signal corresponding to the detected steering angle θs. In the present embodiment, the steering angle sensor 22 corresponds to a turning information detection unit that detects information related to turning of the wheels. The turning device 23 changes the turning angles of the wheels 11a and 11b based on the steering angle θs detected by the steering angle sensor 22. With this kind of configuration, although the steering wheel 21 and the wheels 11a and 11b are not mechanically connected, the turning angles of the wheels 11a and 11b are changed according to the operation of the steering wheel 21 by the driver. In addition, the turning angles of the wheels 11a and 11b can be controlled independently of the steering angle of the steering wheel 21, and thus compared to a so-called mechanical steering device in which the steering wheel 21 and the wheels 11a and 11b are mechanically connected, the control performance of the wheels 11a and 11b can be improved. Note that in the vehicle 10 of the present embodiment, the turning angles of the wheels 11a and 11b are controlled to be the same angle.

The inverter devices 31a and 31b convert DC power supplied from a battery 15 mounted in the vehicle 10 into three-phase AC power, and supply the converted three-phase AC power to the motor generators 32a and 32b, respectively.

The motor generators 32a and 32b operate as electric motors when the vehicle 10 is accelerating. When operating as electric motors, the motor generators 32a and 32b drive based on the three-phase AC power supplied from the inverter devices 31a and 31b. The driving forces of the motor generators 32a and 32b are transmitted to the wheels 11a and 11b, respectively, which rotates the wheels 11a and 11b and causes the vehicle 10 to accelerate.

In addition, the motor generators 32a and 32b operate as power generators when the vehicle 10 is decelerating. In a case where the motor generators 32a and 32b operate as generators, the motor generators 32a and 32b generate power through regenerative operation. A braking force is applied to each of the wheels 11a and 11b by regenerative operation of the motor generators 32a and 32b. The three-phase AC power generated by the regenerative operation of the motor generators 32a and 32b is converted into DC power by the inverter devices 31a and 31b, and the battery 15 is charged.

In this way, in the vehicle 10, a right front wheel 11a and a left front wheel 11b function as drive wheels, and a right rear wheel 11c and a left rear wheel 11d function as driven wheels. Hereinafter, the right front wheel 11a and the left front wheel 11b are also collectively referred to as “drive wheels 11a and 11b”. In this embodiment, the right front wheel 11a corresponds to the right wheel, and the left front wheel 11b corresponds to the left wheel.

In addition, the longitudinal direction of the vehicle 10 is referred to as the “Xc direction”, and the lateral direction of the vehicle 10 is referred to as the “Yc direction”. Furthermore, of the longitudinal direction Xc of the vehicle 10, the traveling direction is referred to as the “Xc1 direction”, and the backward direction is referred to as the “Xc2 direction”. Moreover, of the lateral direction Yc of the vehicle 10, the right direction is referred to as the “Yc1 direction” and the left direction is referred to as the “Yc2 direction”.

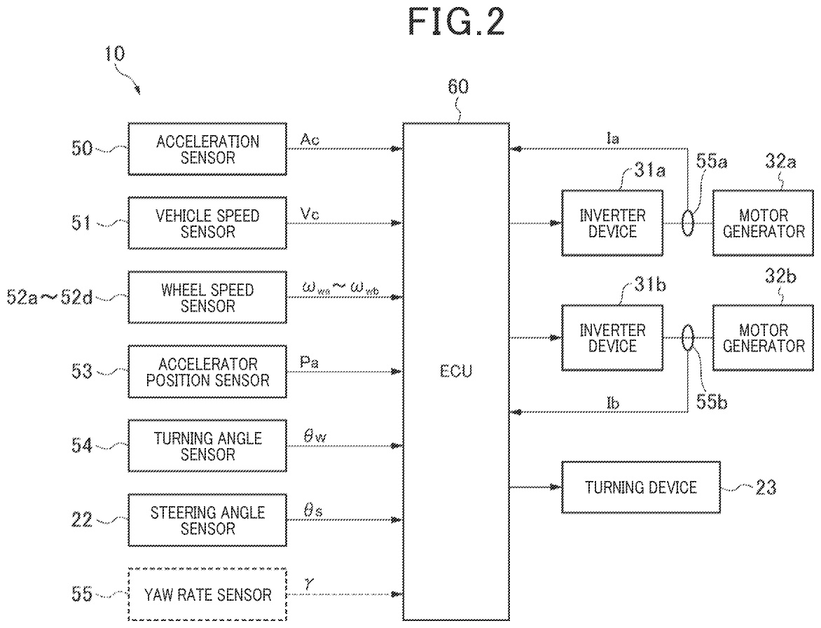

Next, the electrical configuration of the vehicle 10 will be described with reference to FIG. 2.

As illustrated in FIG. 2, the vehicle 10 further includes an acceleration sensor 50, a vehicle speed sensor 51, wheel speed sensors 52a to 52d, an accelerator position sensor 53, a turning angle sensor 54, current sensors 55a and 55b, and an electronic control unit (ECU) 60.

The acceleration sensor 50 detects an acceleration Ac of the vehicle 10 and outputs a signal corresponding to the detected acceleration Ac to the ECU 60. The vehicle speed sensor 51 detects a vehicle speed Vc, which is the traveling speed of the vehicle 10, and outputs a signal corresponding to the detected vehicle speed Vc to the ECU 60. The wheel speed sensors 52a to 52d detect wheel speeds ωwa-ωwd, which are the rotational speeds of the wheels 11a to 11d of the vehicle 10, respectively, and output signals corresponding to the detected wheel speeds ωwa to ωwd to the ECU 60. The accelerator position sensor 53 detects an accelerator position Pa, which is an operating position of an accelerator pedal, and outputs a signal corresponding to the detected accelerator position Pa to the ECU 60. The turning angle sensor 54 detects a turning angle θw of the drive wheels 11a and 11b and outputs a signal corresponding to the detected turning angle θw to the ECU 60. In this embodiment, the turning angle sensor 54 corresponds to a turning angle detection unit. The current sensors 55a and 55b detect phase current values Ia and Ib supplied from the inverter devices 31a and 31b to the motor generators 32a and 32b, respectively, and output signals corresponding to the detected phase current values Ia and Ib to the ECU 60.

The ECU 60 is mainly configured by a microcomputer having a CPU, a memory, and the like. In this embodiment, the ECU 60 corresponds to a control device. The ECU 60 controls the turning device 23 and the motor generators 32a and 32b by executing a program stored in advance in a memory thereof.

More specifically, the ECU 60 takes in output signals from each of the steering angle sensor 22, the acceleration sensor 50, the vehicle speed sensor 51, the wheel speed sensors 52a to 52d, the accelerator position sensor 53, the turning angle sensor 54, and the current sensors 55a and 55b. Based on these output signals, the ECU 60 obtains information on the steering angle θs of the steering wheel 21, the acceleration Ac of the vehicle 10, the vehicle speed Vc, the wheel speeds ωwa to ωwd of the wheels 11a to 11d, the accelerator position Pa, the turning angle θw, and the phase current values Ia and Ib of the motor generators 32a and 32b.

The ECU 60, using maps, arithmetic expressions, and the like, calculates a turning angle command value θw*, which is a target value of the turning angle θw of the drive wheels 1a and 11b, based on the steering angle θs of the steering wheel 21 detected by the steering angle sensor 22, for example, and controls the turning device 23 based on the calculated turning angle command value θw*.

In addition, the ECU 60, based on the vehicle speed Vc and the accelerator position Pa detected by the vehicle speed sensor 51 and the accelerator position sensor 53, calculates torque command values Ta* and Tb*, which are target values of torque to be applied from the motor generators 32a and 32b to the drive wheels 11a and 11b, respectively, using maps, arithmetic expressions, and the like. Then, the ECU 60 controls the energization amounts of each of the motor generators 32a and 32b via the inverter devices 31a and 31b so that the output torques of the motor generators 32a and 32b become the torque command values Ta* and Tb*.

On the other hand, the ECU 60 of the present embodiment not only changes the turning angle θw of the drive wheels 11a and 11b when the vehicle 10 turns, but also improves the turning performance of the vehicle 10 by executing turning control in which the motor generators 32a and 32b apply a driving force or a braking force to the drive wheels 11a and 11b.

Next, before describing the turning control of the present embodiment, the principle of the turning control will be described first.

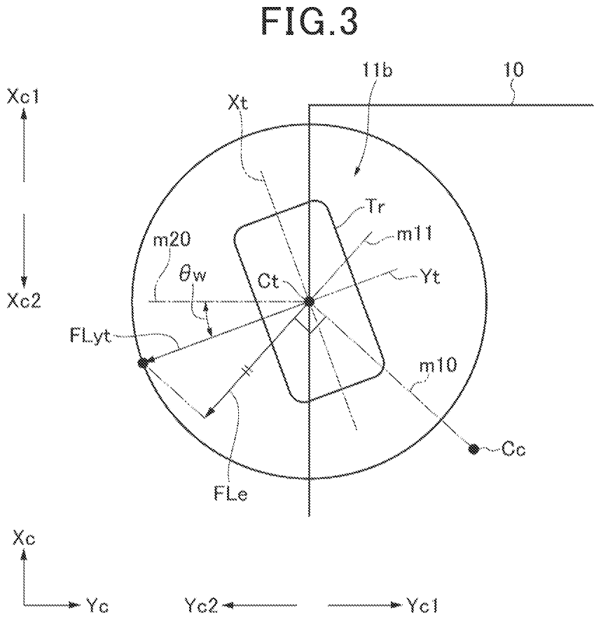

FIG. 3 illustrates with arrows forces applied to the tire Tr of the left front wheel 11b when the vehicle 10 turns. In FIG. 3, the center point of the ground contact surface of the tire Tr of the left front wheel 11b is indicated by “Ct”. Moreover, an axis in the longitudinal direction of the tire Tr of the left front wheel 11b is indicated by “Xt”, and an axis in the lateral direction of the tire of the left front wheel 11b is indicated by “Yt”. Furthermore, the turning center point of the vehicle 10 is indicated by “Cc”. The turning center point Cc of the vehicle 10 corresponds to the position of the center of gravity of the vehicle 10.

For example, when it is presumed that the left front wheel 11b turns at a predetermined turning angle θw as the vehicle 10 turns, as shown in FIG. 3, the lateral direction Yt of the tire Tr of the left front wheel 11b is a direction deviated from the axis m20 parallel to the lateral direction Yc of the vehicle by the turning angle θw in the direction of rotation centered about the ground contact center point Ct of the tire Tr. As the lateral direction Yt of the tire Tr deviates by the turning angle θw in this way, a tire lateral force FLyt, which is a force acting along the lateral direction Yt of the tire Tr, acts on the tire Tr.

On the other hand, when it is presumed that a line connecting the ground contact center point Ct of the tire Tr and a turning center point Cc of the vehicle 10 is a reference line m10, a direction of an effective turning force FLe, which is a force contributing to turning of the vehicle 10, is a direction of an outer product of a direction in which the reference line m10 extends and a vertical direction, which is a direction of a gripping force of the tires Tr. That is, when it is presumed that an axis orthogonal to the reference line m10 is “m11” as illustrated in FIG. 3, the direction of the effective turning force FLe of the vehicle 10 is parallel to the axis m11.

Therefore, when it is presumed that a tire lateral force FLyt acts on the tire Tr, only a force component FLe in the direction along the axis m11 of the tire lateral force FLyt contributes to turning of the vehicle 10. As a result, a part of the tire lateral force FLyt becomes a force that does not contribute to turning of the vehicle 10, and thus becomes a useless force.

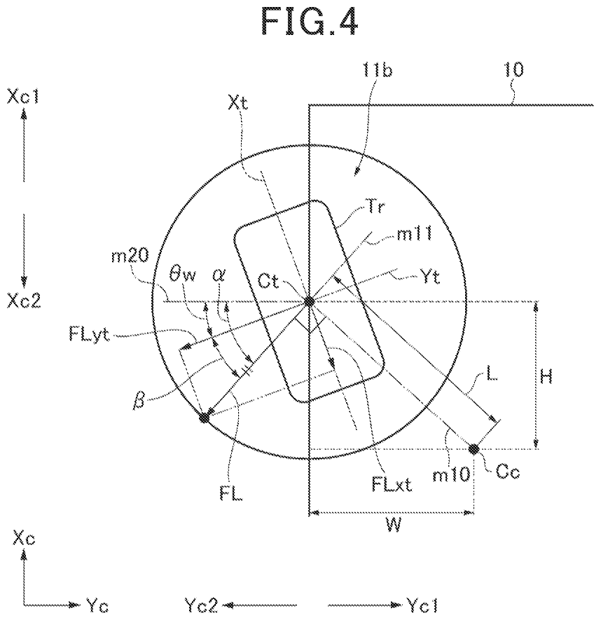

On the other hand, as illustrated in FIG. 4, for example, when a tire longitudinal force FLxt is applied to the tire Tr, a resultant force FL of the tire lateral force FLyt and the tire longitudinal force FLxt acts on the tire Tr. At this time, when the direction of the resultant force FL of the tire Tr is parallel to the axis m11, in other words, when the resultant force FL is orthogonal to the reference line m10, the direction of the resultant force FL of the tire Tr will match the direction of the effective turning force. Therefore, the tire lateral force FLyt can be most efficiently utilized for turning of the vehicle 10, and thus, for example, effects such as improving the acceleration and deceleration of the vehicle 10 when turning, and setting the minimum turning radius of the vehicle 10 to a smaller value can be expected. That is, the turning performance of the vehicle 10 can be improved. Note that the force FL illustrated in FIG. 4 has the same direction and magnitude as the force FLe illustrated in FIG. 3.

Needless to say, the above-described principle that holds true for the left front wheel 11b also holds true for the right front wheel 11a.

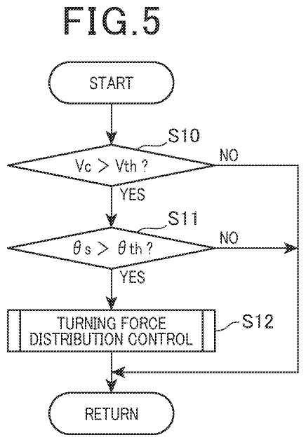

Next, a procedure for performing turning control of the vehicle 10 executed by the ECU 60 using the above principle will be described in detail with reference to FIG. 5 to FIG. 7.

The ECU 60 repeatedly executes the process illustrated in FIG. 5 at a predetermined cycle. As illustrated in FIG. 5, the ECU 60 first, as processing in step S10, determines whether the vehicle speed Vc detected by the vehicle speed sensor 51 is faster than a predetermined speed Vth. The predetermined speed Vth is a determination value for determining whether the vehicle 10 is traveling, and is set to “0 [m/s]”, for example. In a case where the vehicle speed Vc is equal to or less than the predetermined speed Vth, the ECU 60 makes a negative determination in the processing of step S10, and ends the processing illustrated in FIG. 5.

In a case where the vehicle speed Vc is greater than the predetermined speed Vth, the ECU 60 makes a positive determination in the processing of step S10, and in the subsequent processing of step S11, the ECU 60 determines whether the steering angle θs detected by the steering angle sensor 22 is greater than a predetermined angle θth. The predetermined angle θth is a determination value for determining whether the driver intends to turn the vehicle 10. Note that in the processing of step S11, it is desirable that fine adjustment of the steering wheel 21 performed by the driver when the vehicle 10 is traveling straight is not regarded as an intention of turning. Therefore, after learning the steering angle θs of the steering wheel 21 during fine adjustment, the predetermined angle θth is set so that fine adjustment and turning can be distinguished. In the present embodiment, the processing of step S11 corresponds to a process of detecting information related to turning of the wheels.

In a case where the steering angle θs is equal to or less than the predetermined angle θth, the ECU 60 makes a negative determination in the processing of step S11, and ends the process illustrated in FIG. 5. On the other hand, in a case where the steering angle θs is greater than the predetermined angle θth, the ECU 60, in the processing of step S12, executes turning force distribution control. The procedure of this control will be described in detail below.

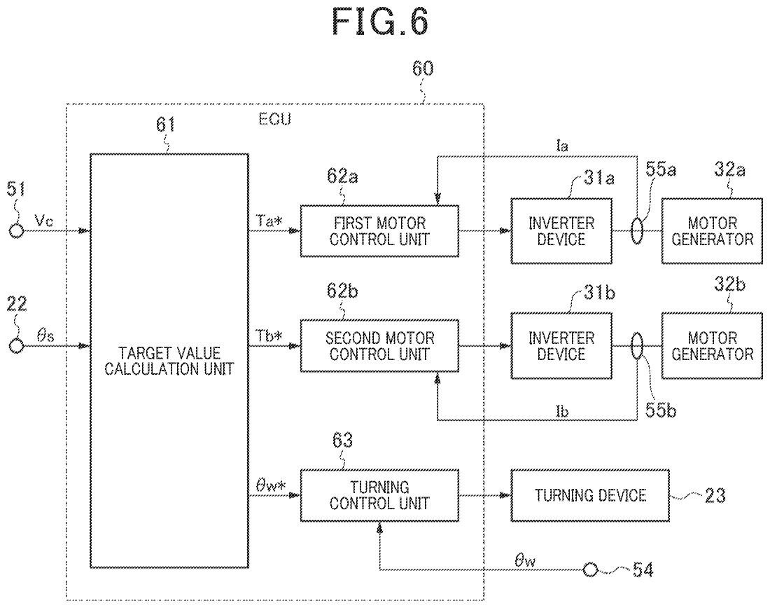

As illustrated in FIG. 6, the ECU 60 includes a target value calculation unit 61, motor control units 62a and 62b, and a turning control unit 63.

The target value calculation unit 61 is a part that calculates torque command values Ta* and Tb* of the motor generators 32a and 32b, respectively, and also calculates a turning angle command value θw* of the drive wheels 11a and 11b.

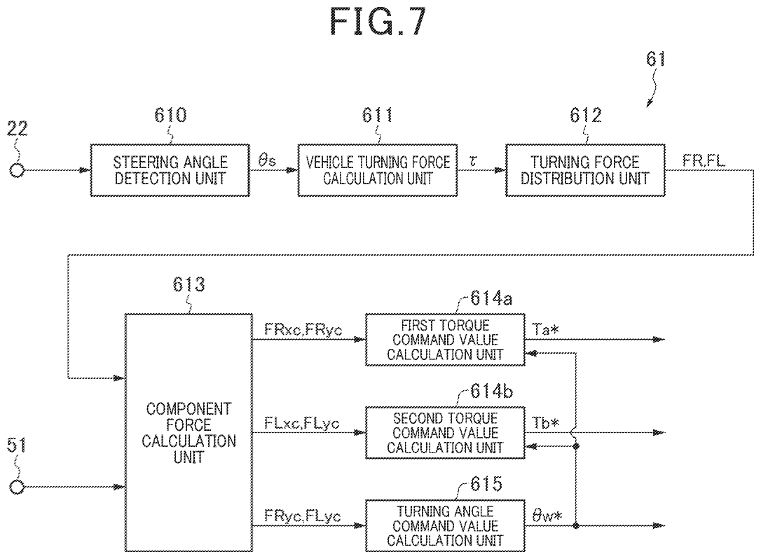

More specifically, as illustrated in FIG. 7, the target value calculation unit 61 includes a steering angle detection unit 610, a vehicle turning force calculation unit 611, a turning force distribution unit 612, a component force calculation unit 613, torque command value calculation units 614a and 614b, and a turning angle command value calculation unit 615.

The steering angle detection unit 610 calculates the steering angle θs of the steering wheel 21 based on an output signal of the steering angle sensor 22 and outputs the calculated steering angle θs to the vehicle turning force calculation unit 611.

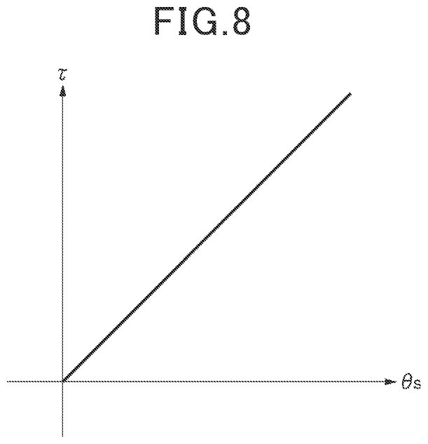

The vehicle turning force calculation unit 611 calculates a vehicle turning force τ based on the steering angle θs obtained by the steering angle detection unit 610. The vehicle turning force τ is a force in the direction of rotation about the turning center point Cc of the vehicle 10 and indicates a basic value of a turning force to be applied to the vehicle 10 to turn the vehicle 10. For example, the vehicle turning force calculation unit 611 obtains the vehicle turning force τ from the steering angle θs using a map as illustrated in FIG. 8. As illustrated in FIG. 8, the vehicle turning force τ is set to a larger value as the steering angle θs increases. As illustrated in FIG. 7, the vehicle turning force calculation unit 611 outputs the calculated vehicle turning force τ to the turning force distribution unit 612.

The turning force distribution unit 612 is a part that distributes the vehicle turning force τ into a right front wheel turning force FR to be applied to the right front wheel 11a and a left front wheel turning force FL to be applied to the left front wheel 11b. More specifically, as illustrated in FIG. 4, when it is presumed that the distance from the turning center point Cc of the vehicle 10 to the ground contact center point Ct of the tire Tr is “L”, the vehicle turning force τ, the right front wheel turning force FR, and the left front wheel turning force FL have the relationship of the following formula f1.

τ=L·(FL+FR) (f1)

On the other hand, in a case where the vehicle 10 turns, so-called weighted movement occurs in which the weight of the wheel located inside a turning locus of the vehicle 10 is transferred to the wheel located outside the turning locus. When it is presumed that this weighted movement amount is “ΔW”, then, for example, in a case where the vehicle 10 is turning right, a vertical load FRz of the right front wheel 11a and the vertical load FRz of the left front wheel 11b acting in a direction perpendicular to the road surface are FLz can be obtained by the following formulas f2 and f3. Note that in formulas f2 and f3, “M” indicates the mass of the vehicle, and “g” indicates the gravitational constant.

FRz=M·g/4−ΔW (f2)

FLz=M·g/4+ΔW (f3)

Moreover, in a case where the vehicle 10 is turning left, a vertical load FRz of the right front wheel 11a and a vertical load FLz of the left front wheel 11b can be found by the following formulas f4 and f5.

FRz=M·g/4+ΔW (f4)

FLz=M·g/4−ΔW (f5)

Note that the weighted movement amount ΔW can be calculated based on formula f6 below. Note that in formula f6, “Vc” indicates the vehicle speed, “R” indicates the turning radius of the vehicle 10, “h” indicates the height of the center of gravity of the wheels from the road surface, and “t” indicates the tread width of the right front wheel 11a and the left front wheel 11b.

ΔW=(M·Vc²/R)·(h/t) (f6)

By using the vertical load FRz of the right front wheel 11a and the vertical load FLz of the left front wheel 11b obtained in this way, the ratio of the right front wheel turning force FR and the left front wheel turning force FL can be set as shown in formula f7 below.

FLz:FRz=FL:FR (17)

As described above, in the present embodiment, the ratio of the right front wheel turning force FR and the left front wheel turning force FL is set to be equal to the ratio of the vertical load FRz of the right front wheel 11a and the vertical load FLz of the left front wheel 11b. In the present embodiment, the ratio between the vertical load FRz of the right front wheel 11a and the vertical load FLz of the left front wheel 11b corresponds to a predetermined distribution ratio.

The turning force distribution unit 612 calculates the right front wheel turning force FR and the left front wheel turning force FL using the formulas f1 to 7. More specifically, the turning force distribution unit 612 obtains the weighted movement amount ΔW based on formula f6 above using the vehicle mass M, the turning radius R of the vehicle 10, the center-of-gravity height h of the wheels, the tread width t, and the vehicle speed Vc detected by the vehicle speed sensor 51. Information on the mass M of the vehicle, the center-of-gravity height h of the wheels, and the tread width t is stored in the memory of the ECU 60 in advance. In addition, the turning force distribution unit 612 extracts the lane shape of the road on which the vehicle 10 is currently traveling from, for example, map information stored in a navigation device mounted on the vehicle 10, and calculates the turning radius R based on the extracted lane shape.

Note that the term “M·Vc²/R” in the above equation f6 can be replaced with “M·a” using the mass M and the lateral acceleration a of the vehicle. Therefore, in a case where the vehicle 10 is equipped with a lateral acceleration sensor, the turning force distribution unit 612 is also able to find the weighted movement amount ΔW based on the lateral acceleration of the vehicle 10 detected by the lateral acceleration sensor and the mass M of the vehicle 10.

In addition, the turning force distribution unit 612 calculates the vertical load FRz on the right front wheel 11a and the vertical load FLz on the left front wheel 11b based on the above formulas f2 to f5 from the weighted movement amount ΔW, the mass M of the vehicle, and the gravitational constant g. Note that the turning force distribution unit 612 uses formulas f2 and f3 in a case where the turning direction of the vehicle 10 is a right turn direction, and uses formulas f4 and f5 in a case where the turning direction of the vehicle 10 is a left turn direction.

The turning force distribution unit 612 calculates the right front wheel turning force FR and the left front wheel turning force FL from the above equations f1 and f7 based on the vertical load FRz on the right front wheel 11a and the vertical load FLz on the left front wheel 11b, the vehicle turning force τ calculated by the vehicle turning force calculation unit 611, and the distance L from the turning center point Cc of vehicle 10 to the ground contact center point Ct of tire Tr. Note that information on the distance L is stored in the memory of the ECU 60 in advance. The turning force distribution unit 612 outputs the calculated right front wheel turning force FR and left front wheel turning force FL to the component force calculation unit 613. The left front wheel turning force FL obtained in this way is used as the force in the direction along the axis m11 illustrated in FIG. 4. In the present embodiment, the right front wheel turning force FR corresponds to a first turning force, and the left front wheel turning force FL corresponds to a second turning force.

As illustrated in FIG. 7, the component force calculation unit 613 calculates a force component FLxc in the vehicle longitudinal direction Xc and a force component FLyc in the vehicle lateral direction Yc from the left front wheel turning force FL calculated by the turning force distribution unit 612 based on formulas f8 and f9 below.

FLxc=FL·sin α (f8)

FLyc=FL·cos α (9)

The angle α, as illustrated in FIG. 4, is an angle formed by the axis m11 and the axis m20, and is stored in the memory of the ECU 60 in advance.

Similarly, the component force calculation unit 613 calculates a force component FRxc in the vehicle longitudinal direction Xc and a force component FRyc in the vehicle lateral direction Yc corresponding to the right front wheel 11a from the right front wheel turning force FR calculated by the turning force distribution unit 612 based on formulas f10 and f11 below.

FRxc=FR·sin α (f10)

FRyc=FR·cos α (f11)

As illustrated in FIG. 7, the component force calculation unit 613 outputs the calculated vehicle lateral force component FRyc of the right front wheel 11a and the calculated vehicle lateral force component FLyc of the left front wheel 11b to the turning angle command value calculation unit 615. In addition, the component force calculation unit 613 outputs the calculated vehicle longitudinal direction force component FRxc and the vehicle lateral direction force component FRyc of the right front wheel 11a to a first torque command value calculation unit 614a, and outputs the calculated vehicle longitudinal direction force component FLxc and the vehicle lateral direction force component FLyc of the left front wheel 11b to a second torque command value calculation unit 614b. In the present embodiment, the vehicle longitudinal direction force components FRxc and FLxc correspond to first directional force components, and the vehicle lateral force components FRyc and FLyc correspond to second directional force components.

The turning angle command value calculation unit 615 calculates a turning angle command value θw* from the vehicle lateral force component FRyc of the right front wheel 11a and the vehicle lateral force component FLyc of the left front wheel 11b calculated by the component force calculation unit 613 based on formula f12 below. Note that “K” in the formula f12 indicates a cornering power of the vehicle 10 (unit: [F/deg]).

(FRyc+FLyc)=K·Func·θw*/cos(θw*) (f12)

In formula f12, “Func” is defined as in formula f13 below. Note that in the formula f13, “M” indicates the mass of the vehicle 10, “L_{WB}” indicates the wheel base length of the vehicle 10, “K” indicates the cornering power of the vehicle 10, and “Vc” indicates the vehicle speed.

$$[ Math 1 ]$$

$$Func = ( 1 - \frac{M}{4 \cdot {L}_{WB} \cdot K} {Vc}^{2} ) \cdot \frac{1}{2} \qquad ( f 13 )$$

Information on the cornering power K and the wheel base length of the vehicle 10 used in the formulas f12 and f13 is stored in the memory of the ECU 60 in advance. In the present embodiment, the cornering power K corresponds to a characteristic value of the tire, and the mass and wheel base length L_{WB} of the vehicle 10 correspond to the specification values of the vehicle 10.

The turning angle command value calculation unit 615 outputs the calculated turning angle command value θw* to the torque command value calculation units 614a and 614b.

The first torque command value calculation unit 614a calculates a tire longitudinal direction force component FRmg of the right front wheel 11a from the left front wheel turning force FL calculated by the turning force distribution unit 612 based on formula f14 below.

FRmg=FL·sin β (f14)

The predetermined angle β in formula f14 is the angle illustrated in FIG. 4. As illustrated in FIG. 4, when the distance from the turning center point Cc of the vehicle 10 to the left front wheel 11b in the vehicle longitudinal direction Xc is taken to be “H”, and the distance from the turning center point Cc of the vehicle 10 to the left front wheel 11b in the vehicle lateral direction Yc is taken to be “W”, the predetermined angle β is defined using the turning angle θw as in formula f15 below. Note that the distance H corresponds to half the wheel base length L_{WB} of the vehicle 10, and the distance W corresponds to half the tread width t of the vehicle 10. The distances H and W are stored in advance in the memory of the ECU 60.

β=180°−(θw+arctan(H/W)+90°) (f15)

The first torque command value calculation unit 614a sets a first torque command value Ta*, which is a target value of the torque to be applied from the motor generator 32a to the right front wheel 11a so that the force at the ground contact surface of the tire of the right front wheel 11a becomes the tire longitudinal direction force component FLmg.

Similarly, the second torque command value calculation unit 614b, by performing a calculation similar to that of the first torque command value calculation unit 614a, sets a second torque command value Tb*, which is a target value of the torque to be applied from the motor generator 32b to the left front wheel 11b.

The first torque command value Ta*, the second torque command value Tb*, and the turning angle command value θw* calculated as illustrated in FIG. 7 are output from the target value calculation unit 61 to the motor control units 62a and 62b and the turning control unit 63, as illustrated in FIG. 6.

The first motor control unit 62a calculates an energization control value, which is a target value for the amount of energization to be supplied to the motor generator 32a, based on the first torque command value Ta*. Then, the first motor control unit 62a drives the inverter device 31a so that each phase current value Ia of the motor generator 32a detected by the current sensor 55a follows the energization control value. As a result, the output torque of the motor generator 32a is controlled to the first torque command value Ta*.

Similar to the first motor control unit 62a, the second motor control unit 62b performs energization control of the motor generator 32a by driving the inverter device 31b based on the second torque command value Tb*. As a result, the output torque of the motor generator 32b is controlled to the second torque command value Tb*.

The turning control unit 63, in order to cause the turning angle θw detected by the turning angle sensor 54 to follow the target turning angle θw*, performs feedback control on the turning device 23 based on deviation between the turning angle θw and the target turning angle θw*. As a result, the turning angle θw of the drive wheels 11a and 11b is controlled to the target turning angle θw*.

With the ECU 60 of the present embodiment described above, it is possible to obtain the actions and effects (1) to (5) below.

(1) As illustrated in FIG. 7, the target value calculation unit 61 calculates a right front wheel turning force FR and a left front wheel turning force FL indicating forces to be applied to the drive wheels 11a and 11b, respectively, based on the steering angle θs, and calculates a turning angle command value θw* and torque command values Ta* and Tb* based on the calculated turning forces FR and FL. As illustrated in FIG. 6, the motor control units 62a and 62b control the output torques of the motor generators 32a and 32b so as to become the torque command values Ta* and Tb*, respectively. Further, the turning control unit 63 controls the turning device 23 so that the turning angle θw of the drive wheels 11a and 11b becomes the turning angle command value θw*. With this configuration, the tire lateral force FLyt and the tire longitudinal force FLxt illustrated in FIG. 4 are applied to the tire Tr of the left front wheel 11b, and thus a turning force FL having a direction along the axis m11 can be applied to the left front wheel 11b. As a result, the turning force FL that can efficiently utilize the tire lateral force FLyt can be applied to the tire Tr of the left front wheel 11b. The same is true for the right front wheel 11a. Therefore, the turning performance of the vehicle 10 can be improved.

(2) As illustrated in FIG. 7, the target value calculation unit 61 breaks down the right front wheel turning force FR and the left front wheel turning force FL into force components FRxc and FLxc having a direction parallel to the vehicle longitudinal direction Xc and force components FRyc and FLyc having a direction parallel to the vehicle lateral direction Yc. In addition, the target value calculation unit 61 calculates the turning angle command value θw* and torque command values Ta* and Tb* based on the force components FRxc, FLxc, FRyc and FLyc. With this configuration, it is possible to easily calculate the turning angle command value θw* and the torque command values Ta* and Tb* corresponding to the right front wheel turning force FR and the left front wheel turning force FL.

(3) As illustrated in FIG. 4, the direction of the left front wheel turning force FL is at an angle of 90 degrees with respect to the reference line m10 connecting the turning center point Cc of the vehicle 10 and the ground contact center point Ct of the tire Tr. In the present embodiment, 90 degrees corresponds to the predetermined angle. The right front wheel turning force FR is also set in the same manner. With this configuration, the vehicle 10 can be turned by making the most efficient use of the tire lateral force, and thus the turning performance of the vehicle 10 can be further improved.

(4) As illustrated in FIG. 7, the target value calculation unit 61 sets the vehicle turning force τ, which is the turning force to be applied to the vehicle 10 to turn the vehicle 10, based on the steering angle θs. Moreover, the target value calculation unit 61, as shown in formula f7 above, distributes the vehicle turning force τ to the right front wheel turning force FR and the left front wheel turning force FL at a distribution ratio composed of a weight ratio of the right front wheel 11a and the left front wheel 11b. With this configuration, the vehicle turning force τ can be easily distributed to the right front wheel turning force FR and the left front wheel turning force FL.

(5) As shown in formulas f12 and f13 above, the target value calculation unit 61 calculates the turning angle command value θw* based on the vehicle lateral force component FRyc of the right front wheel 11a, the vehicle lateral force component FLyc of the left front wheel 11b, the mass M and wheel base length L_{WB}, which are specification values of the vehicle 10, and the cornering power K, which is a tire characteristic value. With this configuration, the turning angle command value θw* can be easily calculated.

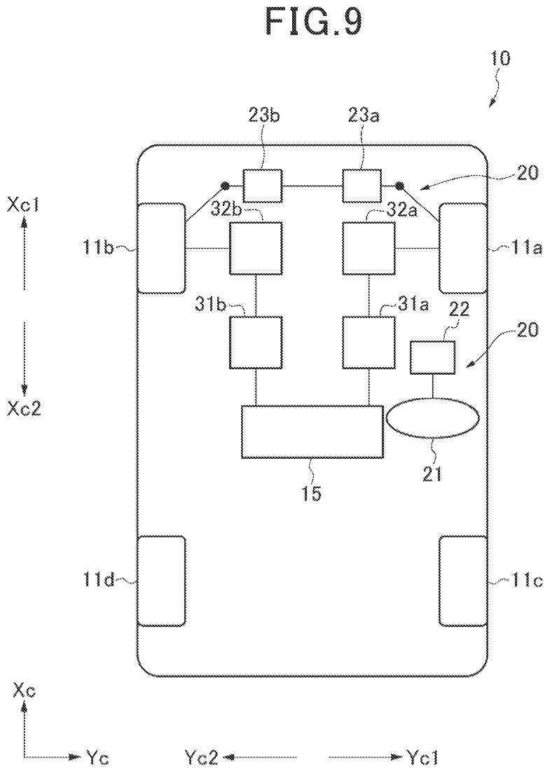

Note that the embodiment described above can also be implemented in the following forms.
In a case where the vehicle 10 accelerates or decelerates while turning, the target value calculation unit 61 may correct the vehicle turning force τ according to the acceleration or deceleration. With this configuration, it becomes possible to calculate a more appropriate vehicle turning force τ according to the acceleration or deceleration of the vehicle 10.
The target value calculation unit 61 may use a calculated value as the cornering power K, which is a characteristic value of the tire, instead of using a value stored in advance in the memory. For example, the target value calculation unit 61 may calculate the cornering power K based on the turning angle θw detected by the turning angle sensor 54 and a yaw rate γ of the vehicle 10 detected by a yaw rate sensor 55 indicated by the dashed line in FIG. 2. In this case, the yaw rate sensor 55 corresponds to a yaw rate detection unit.
The target value calculation unit 61 may use, for example, the weight difference between the right front wheel 11a and the left front wheel 11b instead of the weight ratio of the right front wheel 11a and the left front wheel 11b as the distribution ratio of the right front wheel turning force FR and the left front wheel turning force FL.
An ECU that controls the steering device 20 and an ECU that controls the motor generators 41 and 42 may be provided separately.
As illustrated in FIG. 9, the vehicle 10 may have a turning device 23a for performing turning of the right front wheel 11a and a turning device 23b for performing turning of the left front wheel 11b.
The ECU 60 and control method thereof described in the present disclosure may be achieved by one or a plurality of dedicated computers provided by configuring a processor and memory programmed to execute one or a plurality of functions embodied by a computer program. The ECU 60 and control method thereof described in the present disclosure may be achieved by a dedicated computer provided by configuring a processor that includes one or a plurality of dedicated hardware logic circuits. The ECU 60 and control method thereof described in the present disclosure may be achieved by one or a plurality of dedicated computers configured by a combination of a processor and memory programmed to perform one or more functions and a processor including one or more hardware logic circuits. The computer program may be stored as computer-executable instructions on a computer-readable non-transitional tangible storage medium. Dedicated hardware logic circuits and hardware logic circuits may be achieved by digital circuits including a plurality of logic circuits or by analog circuits.
The present disclosure is not limited to the above specific examples. Configurations obtained by appropriately modifying the designs of the above specific examples by a person skilled in the art are also included in the scope of the present disclosure as long as the features of the present disclosure are provided. Each element included in each specific example described above, and arrangements, conditions, shapes, and the like thereof are not limited to those illustrated and can be modified as appropriate. As long as there are no technical contradictions, combinations of elements included in the specific examples described above may be changed as appropriate.

What is claimed is:

1. A vehicle control device configured to control a traveling vehicle by transmitting torque from an electric motor to a wheel, the vehicle control device comprising:
A motor control unit configured to control the electric motor;
a turning control unit configured to control a turning device that causes turning of the wheel; and
a turning information detection unit configured to detect information related to turning of the wheel; wherein
the vehicle control device is configured to, by the motor control unit controlling the electric motor and the turning control unit controlling the turning device when the turning information detection unit detects information related to turning of the wheel, control a turning force serving as a force to be applied to tire of the wheel in order to turn the vehicle.

2. The vehicle control device according to claim 1, wherein
the motor control unit is configured to control torque of the electric motor so as to become a torque command value;
the turning control unit is configured to control the turning device so that a turning angle of the wheel becomes a turning angle command value; and
the vehicle control device further comprises a target value calculation unit configured to calculate the turning force when information related to turning of the wheel is detected by the turning information detection unit, and to calculate the turning angle command value and the torque command value based on the calculated turning force.

3. The vehicle control device according to claim 2, wherein
the turning information detection unit is a steering angle detection unit configured to detect a steering angle that is a rotation angle of a steering wheel of the vehicle, as information related to the turning of the wheel; and
the target value calculation unit is configured to calculate the turning angle command value and the torque command value based on the steering angle.

4. The vehicle control device according to claim 3, wherein
the direction of the turning force is set to a direction forming a predetermined angle with respect to a reference line that connects a turning center point of the vehicle and a center point of a ground contact surface of the tire; and
the target value calculation unit is configured to:
break down the turning force into a first direction force component that is a component of force having a direction parallel to a longitudinal direction of the vehicle, and a second direction force component that is a component of force having a direction parallel to a lateral direction of the vehicle; and
calculate the turning angle command value and the torque command value based on the first direction force component and the second direction force component.

5. The vehicle control device according to claim 4, wherein
the predetermined angle is 90 degrees.

6. The vehicle control device according to claim 3, wherein
the turning force includes a first turning force to be applied to a tire of a right wheel and a second turning force to be applied to a tire of a left wheel; and
the target value calculation unit is configured to:
set a vehicle turning force serving as a turning force to be applied to the vehicle for turning the vehicle based on the steering angle; and
distribute the vehicle turning force to the first turning force and the second turning force at a predetermined distribution ratio.

7. The vehicle control device according to claim 6, wherein
the target value calculation unit is configured to set the predetermined distribution ratio based on a weight difference or a weight ratio between the right wheel and the left wheel.

8. The vehicle control device according to claim 4, wherein
the target value calculation unit is configured to calculate the turning angle command value based on the second direction force component, a specification value of the vehicle, and a characteristic value of the tire.

9. The vehicle control device according to claim 8, wherein
the target value calculation unit is configured to use a preset value as the characteristic value of the tire.

10. The vehicle control device according to claim 8, further comprising:
a turning angle detection unit configured to detect a turning angle of the vehicle; and
a yaw rate detection unit configured to detect a yaw rate of the vehicle; and
the target value calculation unit is configured to obtain the characteristic value of the tire from the turning angle detected by the turning angle detection unit and the yaw rate detected by the yaw rate detection unit.

11. The vehicle control device according to claim 3, wherein
the target value calculation unit is configured to correct the turning force according to acceleration or deceleration of the vehicle when the vehicle accelerates or decelerates while turning.
